(19) United States
(12) Patent Application Publication
(10) Pub. No.: US 2016/0358258 A1
(43) Pub. Date: Dec. 8, 2016

(54) SYSTEM FOR PERFORMING A STRESS TEST ON A RETIREMENT PLAN

(71) Applicant: Bank of America Corporation, Charlotte, NC (US)

(72) Inventors: Katherine Dintenfass, Charlotte, NC (US); Carrie Anne Hanson, Charlotte, NC (US); Daralyn Marie Nicholson, Charlotte, NC (US); Cameron Darnell Wadley, Waxhaw, NC (US)

(21) Appl. No.: 14/728,289

(22) Filed: Jun. 2, 2015

(51) Int. Cl. G06Q 40/06

(52) U.S. Cl. CPC G06Q 40/06

(57) ABSTRACT

Embodiments of the invention are directed to systems, methods, and computer program products for performing a stress test on a retirement plan. The system is configured to calculate a retirement score for a retirement plan of a user based on one or more parameters; determine one or more life events likely to occur for the user; perform a stress test on the retirement plan of the user to determine whether the retirement plan is capable of withstanding the one or more life events; provide recommendations to the user if the retirement plan of the user is not capable of withstanding the one or more life events.

### FIELD

In general, embodiments of the invention relate to retirement planning, in particular, embodiments of the invention relate to a framework for assessment of retirement planning by providing a retirement score for a user and applying a stress test on the retirement score to determine the stability of the user's retirement plan.

### BACKGROUND

Retirement planning, in a financial context, refers to the allocation of savings or revenue for retirement in an attempt to achieve financial independence, so that the need to be gainfully employed is optional rather than a necessity. Most retirement planning models provide a target sum that the user should save before retirement, but fail to consider other costs that may change retirement planning over time and determine the readiness of the user to retire over a period of time.

### BRIEF SUMMARY

Embodiments of the present invention address the above needs and/or achieve other advantages by providing apparatuses (e.g., a system, computer program product, and/or other device) and methods for performing a stress test on a retirement plan of the user. The present invention provides the functional benefit of determining whether the user's retirement plan can withstand one or more life events likely to occur for the user. In doing so, the user may have the information required to make key financial choices to ensure that the retirement plan is robust.

In one aspect, a system for performing a stress test on a retirement plan is presented. The system comprises one or more memory devices; and one or more processing devices operatively coupled to the one or more memory devices, wherein the one or more processing devices are configured to execute computer-readable program code to: receive one or more parameters associated with the financial institution accounts of the user from a distributed network of servers, wherein the one or more parameters comprises at least asset values, liability values, and estimated rates of return associated with assets that provide returns; determine a user profile associated with the user, the user profile comprising an age of the user; determine financial behavior of the user, wherein the financial behavior comprises at least one of a spending behavior, investment behavior, and savings behavior; calculate a retirement score for a retirement plan of a user based on the one or more parameters, wherein the one or more parameters comprise at least asset values, liability values, the user profile, the estimated rates of return associated with assets that provide returns, and a financial behavior of the user, wherein the retirement score indicates the user's preparedness for retirement at a future predetermined date, wherein the future predetermined date is selected by the user; determine one or more life events likely to occur for the user, wherein the one or more life events comprises a life event score; perform a stress test on the retirement plan of the user based on at least the one or more life events, wherein performing a stress comprises: calculating an updated retirement score based on at least the one or more life event scores associated with the one or more life events likely to occur for the user; compare the updated retirement score to a predetermined threshold associated with the retirement score; and determine whether the retirement plan of the user is capable of withstanding the one or more life events based on at least the comparison; and provide one or more recommendations to the user based on at least determining that the retirement plan of the user is not capable of withstanding the one or more life events.

In some embodiments, the module is configured to cause the one or more processing devices to determine the one or more life events likely to occur for the user based on at least the user profile and one or more life events that have occurred to peer users with peer user profiles substantially similar to the user profile.

In some embodiments, the module is configured to cause the one or more processing devices to: determine one or more weights associated with the likelihood of the one or more life events determined to occur for the user; and calculate the updated retirement score based on at least weighting the one or more life event scores likely to occur for the user.

In some embodiments, the module is configured to cause the one or more processing devices to: initiate the stress test on the retirement plan based on a predetermined threshold associated with the one or more weights, wherein the stress test is initiated when a value of at least one of the one or more weights is greater than the predetermined threshold.

In some embodiments, the module is configured to cause the one or more processing devices to: vary a value of the one or more weights associated with the likelihood of the one or more life events determined to occur for the user, wherein the value of the one or more weights is varied based on at least the user's profile.

In some embodiments, the module is configured to cause the one or more processing devices to: perform the stress test on the retirement plan of the user at one or more time intervals associated with the one or more life events, wherein the one or more time intervals are based on at least the user's age.

In some embodiments, the module is configured to cause the one or more processing devices to: enable the user to customize the one or more life events determined likely to occur for the user.

In another aspect, a computer program product for performing a stress test on a retirement plan is presented. The computer program product comprises a non-transitory computer-readable medium comprising code causing a first apparatus to: receive one or more parameters associated with the financial institution accounts of the user from a distributed network of servers, wherein the one or more parameters comprises at least asset values, liability values, and estimated rates of return associated with assets that provide returns; determine a user profile associated with the user, the user profile comprising an age of the user; determine financial behavior of the user, wherein the financial behavior comprises at least one of a spending behavior, investment behavior, and savings behavior; calculate a retirement score for a retirement plan of a user based on the one or more parameters, wherein the one or more parameters comprise at least asset values, liability values, the user profile, the estimated rates of return associated with assets that provide returns, and a financial behavior of the user, wherein the retirement score indicates the user's preparedness for retirement at a future predetermined date, wherein the future predetermined date is selected by the user; determine one or more life events likely to occur for the user, wherein the one or more life events comprises a life event score; perform a stress test on the retirement plan of the user based on at least the one or more life events, wherein performing a stress comprises: calculating an updated retirement score based on at least the one or more life event scores associated with the one or more life events likely to occur for the user; compare the updated retirement score to a predetermined threshold associated with the retirement score; and determine whether the retirement plan of the user is capable of withstanding the one or more life events based on at least the comparison; and provide one or more recommendations to the user based on at least determining that the retirement plan of the user is not capable of withstanding the one or more life events.

In another aspect, a computer implemented method for performing a stress test on a retirement plan is presented. The method comprising: receiving, using a computing device processor, one or more parameters associated with the financial institution accounts of the user from a distributed network of servers, wherein the one or more parameters comprises at least asset values, liability values, and estimated rates of return associated with assets that provide returns; determining, using a computing device processor, a user profile associated with the user, the user profile comprising an age of the user; determining, using a computing device processor, financial behavior of the user, wherein the financial behavior comprises at least one of a spending behavior, investment behavior, and savings behavior; calculating, using a computing device processor, a retirement score for a retirement plan of a user based on the one or more parameters, wherein the one or more parameters comprise at least asset values, liability values, the user profile, the estimated rates of return associated with assets that provide returns, and a financial behavior of the user, wherein the retirement score indicates the user's preparedness for retirement at a future predetermined date, wherein the future predetermined date is selected by the user; determining, using a computing device processor, one or more life events likely to occur for the user, wherein the one or more life events comprises a life event score; performing, using a computing device processor, a stress test on the retirement plan of the user based on at least the one or more life events, wherein performing a stress comprises: calculating an updated retirement score based on at least the one or more life event scores associated with the one or more life events likely to occur for the user; compare the updated retirement score to a predetermined threshold associated with the retirement score; and determine whether the retirement plan of the user is capable of withstanding the one or more life events based on at least the comparison; and providing, using a computing device processor, one or more recommendations to the user based on at least determining that the retirement plan of the user is not capable of withstanding the one or more life events.

### BRIEF DESCRIPTION OF THE DRAWINGS

Having thus described embodiments of the invention in general terms, reference will be made to the accompanying drawings, where:

FIG. 1 presents an exemplary block diagram of the system environment 100 for implementing the process flows described herein in accordance with embodiments of the present invention;

FIG. 2 presents a high level process flow for determining whether a retirement plan can withstand one or more life events, in accordance with an embodiment of the invention; and

FIG. 3 presents a process flow for performing a stress test on a retirement plan, in accordance with an embodiment of the invention.

### DETAILED DESCRIPTION OF THE INVENTION

Embodiments of the present invention now may be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure may satisfy applicable legal requirements. Like numbers refer to like elements throughout.

In some embodiments, a “user” may be a financial institution customer (e.g., an account holder or a person who have an account (e.g., banking account, credit account, or the like)). In one aspect, a user may be any financial institution customer involved in retirement planning with the financial institution or any other affiliate entities associated with the financial institution. In some embodiments, the user may be an individual who may be interested in opening an account with the financial institution. In some other embodiments, a user may be any individual who may be interested in enrolling in the retirement plan offered by the financial institution. In some embodiments, a “user” may be a financial institution employee (e.g., an underwriter, a project manager, an IT specialist, a manager, an administrator, an internal operations analyst, bank teller or the like) capable of operating the system described herein. For purposes of this invention, the term “user” and “customer” may be used interchangeably.

In some embodiments, an “entity” as used herein may be a financial institution. For the purposes of this invention, a “financial institution” may be defined as any organization, entity, or the like in the business of moving, investing, or lending money, dealing in financial instruments, or providing financial services. This may include commercial banks, thrifts, federal and state savings banks, savings and loan associations, credit unions, investment companies, insurance companies and the like. In some embodiments, the entity may allow a user to establish an account with the entity. An “account” may be the relationship that the user has with the entity. Examples of accounts include a deposit account, such as a transactional account (e.g. a banking account), a savings account, an investment account, a money market account, a time deposit, a demand deposit, a pre-paid account, a credit account, a non-monetary user profile that includes only personal information associated with the user, or the like. The account is associated with and/or maintained by an entity. In other embodiments, an “entity” may not be a financial institution.

As used herein, a “user interface” may be a graphical user interface. Typically, a graphical user interface (GUI) is a type of interface that allows users to interact with electronic devices such as graphical icons and visual indicators such as secondary notation, as opposed to using only text via the command line. In some embodiments, the graphical user interface may include both graphical elements and text elements.

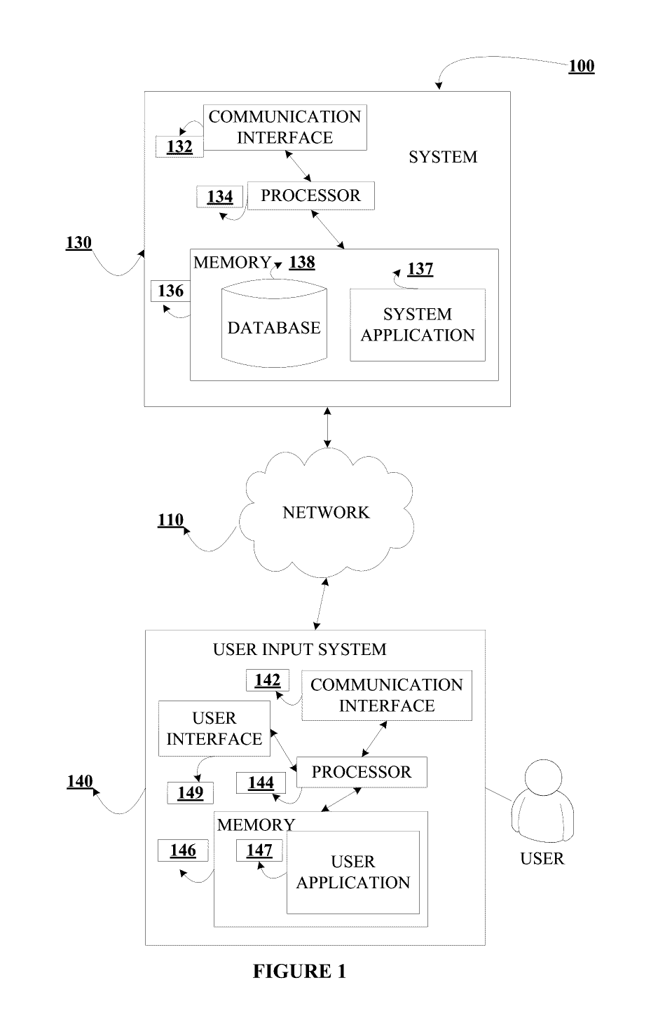

FIG. 1 presents an exemplary block diagram of the system environment 100 for implementing the process flows described herein in accordance with embodiments of the present invention. As illustrated, the system environment 100 includes a network 110, a system 130, and a user input system 140. Also shown in FIG. 1 is a user of the user input system 140. The user input system 140 may be a mobile device or other non-mobile computing device. The user may be a person who uses the user input system 140 to execute a user application 147. The user application 147 may be an application to communicate with the system 130, perform a transaction, input information onto a user interface presented on the user input system 140, or the like. The user application 147 and/or the system application 137 may incorporate one or more parts of any process flow described herein.

As shown in FIG. 1, the system 130, and the user input system 140 are each operatively and selectively connected to the network 110, which may include one or more separate networks. In addition, the network 110 may include a telecommunication network, local area network (LAN), a wide area network (WAN), and/or a global area network (GAN), such as the Internet. It will also be understood that the network 110 may be secure and/or unsecure and may also include wireless and/or wired and/or optical interconnection technology.

The user input system 140 may include any computerized apparatus that can be configured to perform any one or more of the functions of the user input system 140 described and/or contemplated herein. For example, the user may use the user input system 140 to transmit and/or receive information or commands to and from the system 130. In some embodiments, for example, the user input system 140 may include a personal computer system (e.g. a non-mobile or non-portable computing system, or the like), a mobile computing device, a personal digital assistant, a mobile phone, a tablet computing device, a network device, and/or the like. As illustrated in FIG. 1, in accordance with some embodiments of the present invention, the user input system 140 includes a communication interface 142, a processor 144, a memory 146 having an user application 147 stored therein, and a user interface 149. In such embodiments, the communication interface 142 is operatively and selectively connected to the processor 144, which is operatively and selectively connected to the user interface 149 and the memory 146. In some embodiments, the user may use the user application 147 to execute processes described with respect to the process flows described herein. Specifically, the user application 147 executes the process flows described herein.

Each communication interface described herein, including the communication interface 142, generally includes hardware, and, in some instances, software, that enables the user input system 140, to transport, send, receive, and/or otherwise communicate information to and/or from the communication interface of one or more other systems on the network 110. For example, the communication interface 142 of the user input system 140 may include a wireless transceiver, modem, server, electrical connection, and/or other electronic device that operatively connects the user input system 140 to another system such as the system 130. The wireless transceiver may include a radio circuit to enable wireless transmission and reception of information. Additionally, the user input system 140 may include a positioning system. The positioning system (e.g. a global positioning system (GPS), a network address (IP address) positioning system, a positioning system based on the nearest cell tower location, or the like) may enable at least the user input system 140 or an external server or computing device in communication with the user input system 140 to determine the location (e.g. location coordinates) of the user input system 140.

Each processor described herein, including the processor 144, generally includes circuitry for implementing the audio, visual, and/or logic functions of the user input system 140. For example, the processor may include a digital signal processor device, a microprocessor device, and various analog-to-digital converters, digital-to-analog converters, and other support circuits. Control and signal processing functions of the system in which the processor resides may be allocated between these devices according to their respective capabilities. The processor may also include functionality to operate one or more software programs based at least partially on computer-executable program code portions thereof, which may be stored, for example, in a memory device, such as in the user application 147 of the memory 146 of the user input system 140.

Each memory device described herein, including the memory 146 for storing the user application 147 and other information, may include any computer-readable medium. For example, memory may include volatile memory, such as volatile random access memory (RAM) having a cache area for the temporary storage of information. Memory may also include non-volatile memory, which may be embedded and/or may be removable. The non-volatile memory may additionally or alternatively include an EEPROM, flash memory, and/or the like. The memory may store any one or more of pieces of information and data used by the system in which it resides to implement the functions of that system.

As shown in FIG. 1, the memory 146 includes the user application 147. In some embodiments, the user application 147 includes an interface for communicating with, navigating, controlling, configuring, and/or using the user input system 140. In some embodiments, the user application 147 includes computer-executable program code portions for instructing the processor 144 to perform one or more of the functions of the user application 147 described and/or contemplated herein. In some embodiments, the user application 147 may include and/or use one or more network and/or system communication protocols.

Also shown in FIG. 1 is the user interface 149. In some embodiments, the user interface 149 includes one or more output devices, such as a display and/or speaker, for presenting information to the user. In some embodiments, the user interface 149 includes one or more input devices, such as one or more buttons, keys, dials, levers, directional pads, joysticks, accelerometers, controllers, microphones, touchpads, touchscreens, haptic interfaces, microphones, scanners, motion detectors, cameras, and/or the like for receiving information from the user. In some embodiments, the user interface 149 includes the input and display devices of a mobile device, which are operable to receive and display information.

FIG. 1 also illustrates a system 130, in accordance with an embodiment of the present invention. The system 130 may refer to the “apparatus” described herein. The system 130 may include any computerized apparatus that can be configured to perform any one or more of the functions of the system 130 described and/or contemplated herein. In accordance with some embodiments, for example, the system 130 may include a computer network, an engine, a platform, a server, a database system, a front end system, a back end system, a personal computer system, and/or the like. Therefore, the system 130 may be a server managed by the business. The system 130 may be located at the facility associated with the business or remotely from the facility associated with the business. In some embodiments, such as the one illustrated in FIG. 1, the system 130 includes a communication interface 132, a processor 134, and a memory 136, which includes a system application 137 and a structured database 138 stored therein. As shown, the communication interface 132 is operatively and selectively connected to the processor 134, which is operatively and selectively connected to the memory 136.

It will be understood that the system application 137 may be configured to implement any one or more portions of the various user interfaces and/or process flow described herein. The system application 137 may interact with the user application 147. It will also be understood that, in some embodiments, the memory includes other applications. It will also be understood that, in some embodiments, the system application 137 is configured to communicate with the structured database 138, the user input system 140, or the like.

It will be further understood that, in some embodiments, the system application 137 includes computer-executable program code portions for instructing the processor 134 to perform any one or more of the functions of the system application 137 described and/or contemplated herein. In some embodiments, the system application 137 may include and/or use one or more network and/or system communication protocols.

In addition to the system application 137, the memory 136 also includes the structured database 138. As used herein, the structured database 138 may be one or more distinct and/or remote databases. In some embodiments, the structured database 138 is not located within the system and is instead located remotely from the system. In some embodiments, the structured database 138 stores information or data described herein.

It will be understood that the structured database 138 may include any one or more storage devices, including, but not limited to, datastores, databases, and/or any of the other storage devices typically associated with a computer system. It will also be understood that the structured database 138 may store information in any known way, such as, for example, by using one or more computer codes and/or languages, alphanumeric character strings, data sets, figures, tables, charts, links, documents, and/or the like. Further, in some embodiments, the structured database 138 may include information associated with one or more applications, such as, for example, the system application 137. It will also be understood that, in some embodiments, the structured database 138 provides a substantially real-time representation of the information stored therein, so that, for example, when the processor 134 accesses the structured database 138, the information stored therein is current or substantially current.

It will be understood that the embodiment of the system environment illustrated in FIG. 1 is exemplary and that other embodiments may vary. As another example, in some embodiments, the system 130 includes more, less, or different components. As another example, in some embodiments, some or all of the portions of the system environment 100 may be combined into a single portion. Likewise, in some embodiments, some or all of the portions of the system 130 may be separated into two or more distinct portions.

In addition, the various portions of the system environment 100 may be maintained for and/or by the same or separate parties. It will also be understood that the system 130 may include and/or implement any embodiment of the present invention described and/or contemplated herein. For example, in some embodiments, the system 130 is configured to implement any one or more of the embodiments of the process flows described and/or contemplated herein in connection any process flow described herein. Additionally, the system 130 or the user input system 140 is configured to initiate presentation of any of the user interfaces described herein.

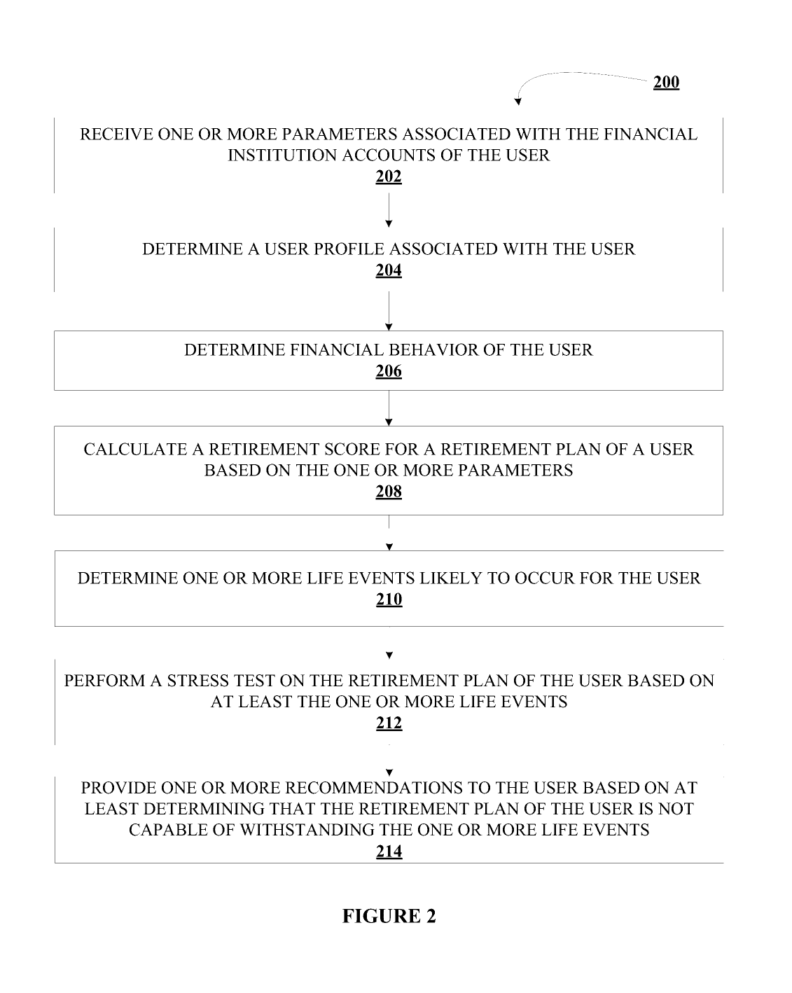

FIG. 2 illustrates a high level process flow for determining whether a retirement plan can withstand one or more life events 200. As illustrated by block 202, embodiments of the invention comprise receiving one or more parameters associated with the financial institution accounts of the user from a distributed network of servers, wherein the one or more parameters comprises at least asset values, liability values, and estimated rates of return associated with assets that provide returns. Typically, the assets include illiquid assets and liquid assets. The user's assets may include but are not limited to checking accounts, savings accounts, investment accounts (e.g., with regular disbursements and penalties for principal withdrawals, or self-directed accounts that more liquid without penalties), annuity accounts (e.g., social security, claim awards, reverse mortgages, or the like), insurances benefit accounts (e.g., one time or reoccurring), property owned by the user (e.g., investment property, rental property, or the like), or other like assets that may provide regular or semi-regular recurring payments, assets that are or are similar to cash accounts, or assets that need to be sold in order to realize cash values of the assets. In some embodiments the assets may be illiquid (e.g., have penalties or may take time to convert into cash) or may be liquid (e.g., can be converted to cash in a couple of days without penalty). In one aspect, the process flow includes determining a user's asset values (e.g., balances of the account, current or estimated future fair market values of the property, or the like) and liability values (e.g., amount owed, or the like). The user's liabilities may include a mortgage, long and short term debit, payments owed on other personal property or legal judgments against the user, or the like).

In some embodiments, the one or more parameters may include determining fund in-flows and fund out-flows for the assets and liabilities over a past time period by analyzing transactions for the assets and the liabilities. In one aspect, the fund in-flows include funds received from or deposited into the user's assets (e.g., user's accounts, or the like), such as paychecks, 401K disbursements, pension disbursements, or the like. The past out-flows from the user's assets (e.g., user's accounts, or the like) are determined, such as payments for housing (e.g., rent or mortgage), bills, health care insurance and other costs, heat, water, food, or like, which illustrates all of the essential (e.g., necessary or necessary to the user) costs that cover what the user currently uses to live. In some embodiments, all of the assets and liabilities are determined in order to get an idea of what the values of the assets and liabilities are in order to determine how long the inflows and outflows for the user may last.

In addition, the system may be configured to determine estimated rates of return for the assets that provide returns. In some embodiments, the assets may include estimated rates of returns such that not only are the disbursements used in determining the retirement score, but the principal and growth of the principal over time may be used in determining the retirement score.

As shown in block 204, embodiments of the invention further include determining a user profile comprising an age of the user, wherein the user profile indicates a lifestyle of the user. In this regard, the system may be configured to determine the user profile based on at least one or more past transactions of the user, a geographic location of the user, an income level, an amount of outgoing funds, asset values, liability values, asset types, spending habits, saving habits or the like. In one aspect, the user profile includes at least information identifying the user. In some embodiments, the system may be configured to establish predefined user profiles including, but not limited to travel profiles, homebody, luxury spender, thrifty saver, risk taker, or the like. For example, for the thrifty saver lifestyle the user may indicate that he/she may downsize the user's home in retirement, sell a vacation home, reduce travel expenses, or the like. The profiles may be pre-programed by the financial institution and/or programmable by the user to illustrate how the user plans on living in retirement. Other lifestyles illustrate if the user will spend less, the same, or more during retirement.

In some embodiments, the system may be configured to enable the user to customize the user profile. In this regard, the system may be configured to enable the user to select at least one of the predetermined user profiles and customize the at least one selected user profile according to the characteristics of the user by providing additional information. In one aspect, the system may be configured to initiate presentation of one or more selectable options on the retirement planning interface on the user device to enable the user to provide the additional information to customize the selected predetermined user profile.

As shown in block 206, embodiments of the invention further include determining financial behavior of the user, wherein the financial behavior comprises at least one of a spending behavior, investment behavior, and savings behavior. In one aspect, determining financial behavior of the user may include determining a spending pattern, investment pattern, and savings pattern of the user over a predetermined past period of time. In one aspect, determining the financial behavior of the user is based on at least the user profile. In this regard, the system may be configured to generate one or more predetermined questions to enable the user to provide additional information regarding the user's financial behavior to the system. In one aspect, the predetermined questions may enable the system to receive information associated with the personality, values, opinions, attitudes, interests, lifestyles, or the like of the user.

Next at block 208, embodiments of the invention further include calculating a retirement score for the user based on one or more parameters, wherein the one or more parameters comprise at least the asset values, the liability values, the user profile, the estimated rates of return, and the financial behavior of the user, wherein the retirement score indicates the user's preparedness for retirement at a future predetermined date, wherein the future predetermined date is selected by the user.

In some embodiments, the retirement score is calculated based on one or more parameters. Some of these parameters (e.g., fund in-flows and fund out-flows) may include continuously varying values which when used to calculate the retirement score may not result in the most accurate representation of the retirement score. In this regard, the system may be configured to represent the retirement score according to a confidence score. The confidence score may be represented in any format including, but not limited to, a percentage, a ranking, a numerical value, or the like. In doing so, the user may be able to gauge the accuracy of the retirement score. For example, a retirement score of 40/100 with a confidence score of 50% may indicate that the retirement score may not be the most accurate representation of the retirement score with a confidence level of only 50%. A lower confidence score may indicate that the data (one or more parameters) used in the calculation of the retirement score are either incomplete or dated. The enables the user to review the information initially provided and update the information to retrieve an accurate representation of the retirement score.

At block 210, embodiments of the invention further include determining one or more life events likely to occur for the user, wherein the one or more life events comprise a life event score. Typically, the like events likely to occur for the user at a future period of time. Additionally, the system may determine whether the life event likely to occur for the user occurs for the user individually, or together with another user. In this regard, another user may be associated with the user's household (e.g., spouse, parents, children, dependents, or the like). For example, a life event likely to occur for the user may be purchasing a home, planning a wedding, planning a trip, a health event, or the like. In one aspect, the life event likely to occur for the user may be a life event that actually will occur for one or more other users associated with the user (e.g., in the user's household), whose effect will affect the calculated retirement score of the user. For example, a life event likely to occur for the user may be paying for a dependent to go to college, a divorce, or the like. In some embodiments, the system may be configured to enable the user to customize the one or more life events determined likely to occur for the user. In this regard, the user may select one or more life events determined by the system to likely occur for the user.

In some embodiments, the system may be configured to determine the one or more life events likely to occur for the user based on the user profile and/or the financial behavior of the user. In this regard, the system may be configured to determine one or more life events that have occurred for one or more users with substantially similar user profile and/or the financial behavior. In one aspect, information associated with the one or more life events may be received from the one or more users with substantially similar user profile and/or the financial behavior as that of the user. In some embodiments, the system may be configured to assign weights to information associated with one or more life events selected by one or more users with substantially similar profiles and/or the financial behavior as the user for information retrieval. In this regard, the system may assign predetermined weights for predetermined information associated with the one or more life events. In one aspect, assigning predetermined weights may be based on at least comparing event information associated with the one or more life events selected by the one or more users with substantially similar profiles and/or the financial behavior to determine a match. For example, a user currently living in Hawaii may wish to purchase a house in Hawaii. The system may be configured to compare the location of properties with substantially similar size purchased by the one or more users with substantially similar profiles as that of the user based on a surrounding geographic area, locations with similar cost of living, taxes, or the like. In this regard, matching event information may be assigned a higher weight. For example, the user wishes to attend college at a public university in a college town, the system may assign a higher weight to information selected by the one or more users with substantially similar profiles and/or the financial behavior as the user who previously selected a life event to attend college at a public university. In contrast, the system may assign a lower weight to information selected by the one or more users with substantially similar profiles and/or the financial behavior as the user who previously selected a life event to attend college at a private university in a city. Accordingly, the system may be configured to calculate a life event score for each life event selected by the user.

Next at block 212, embodiments of the invention further include performing a stress test on the retirement plan of the user based on at least one or more life events, wherein performing the stress test further comprises comparing the updated retirement score to a predetermined threshold associated with the retirement score. Typically, a stress test is an analysis or simulation designed to determine the ability of the retirement plan to deal with an economic crises (e.g., the life events). In doing so, the system may provide an actuarial perspective on the user's retirement plan and enhance the understanding of the retirement plan for the user by exposing the financial vulnerability of the retirement plan, if any. In some embodiments, the stress test may be performed either at a point in time, or over a period of time.

In some embodiments, the system may determine that the updated retirement score is lower than the predetermined threshold. In response, as shown in block 214, embodiments of the invention further include providing one or more recommendations to the user based on at least determining that the retirement plan of the user is not capable of withstanding the one or more life events. These recommendations include location changes, financial product changes, or the like. In one aspect, the recommendation may be an investment plan for at least a portion of the assets of the user. In another aspect, the recommendation may be payoff plan for paying off at least a portion of the liabilities (or obligations) using at least one of the illiquid assets or the liquid assets. In this regard, the recommendation may include a refinancing option to enable the user to increase an amount of funds allocated for savings to hedge against the updated retirement score. In some embodiments, the system may automatically shift the user into an appropriate financial product for retirement score improvement. In general, the recommendation may include tips to enable the user to maintain or increase the retirement score. In some embodiments, the system may be configured to provide a recommendation to the user based on both the updated retirement score and the likelihood of the life event occurring for the user. For example, the system may recommend that the user increase an amount of funds allocated towards the user's savings for an increased likelihood of the life event occurring for the user.

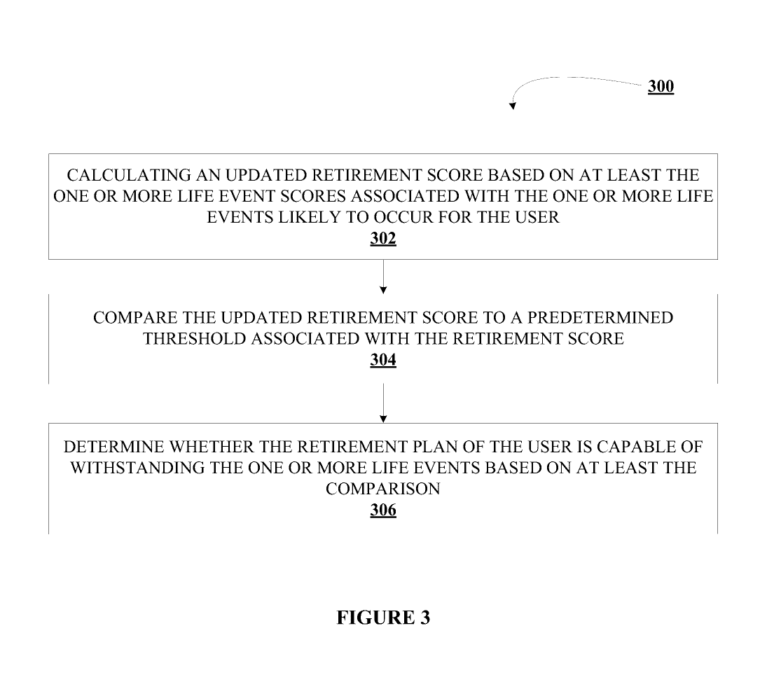

FIG. 3 illustrates a process flow for performing a stress test on a retirement plan of the user, in accordance with an embodiment of the invention. As shown in block 302, the process flow includes calculating an updated retirement score based on at least the one or more life event scores associated with the one or more life events likely to occur for the user. In this regard, the likelihood of the life events occurring for the user may be represented by weighting the one or more life events based on at least similar life events occurring for one or more other users with substantially similar user profiles and/or the financial behavior. For example, the system may assign a higher weight to the likelihood of the user in his/her thirties to purchase a home and a lower weight to the likelihood of the same user to undergo a medical procedure.

In some embodiments, the weights assigned to the likelihood of one or more life events that could occur for the user may change based on at least the user's age, the user's profile, and/or the financial behavior of the user. Continuing with the previous example, while the system may assign a higher weight for the likelihood of the user to purchase home during the user's thirties, the system may assign a lower weight for the likelihood of the user to purchase home during the user's fifties. The system may gradually increase the value of the one or more weights associated with the life events as the likelihood of the life event likely to occur for the user increases and similarly decrease the value of the one or more weights as the likelihood of the life event likely to occur for the user decreases. In this regard, the system may be configured to vary the value of the one or more weights based on a predetermined probabilistic distribution (e.g., normal distribution). In some embodiments, the weights for one or more life events may be set to zero if the one or more life events is determined to not occur for the user. For example, a user whose marital status is “single” will not have “divorce” as a possible life event.

The system may then be configured to calculate the updated retirement score based on at least weighting the one or more life event scores likely to occur for the user. In one aspect, the retirement scores may be updated periodically and/or at predetermined intervals. In some embodiments, the system may be configured to perform the stress test on the retirement plan for each life event individually. In other embodiments, the system may be configured to perform the stress test to on a combination of life events that could occur for the user. In this regard, the system may be configured to retrieve additional information associated with the user and the life event to perform the stress test. For example, if the life event is a medical procedure or any such health event, the system may receive insurance information of the user to be taken into account when performing the stress to determine an insurance contribution to the life event. In one aspect, the system may be configured to perform the stress test on the retirement plan based on a predetermined threshold associated with the weights. In doing so, the system may calculate the updated retirement score when the likelihood of the life event likely to occur for the user, as reflected by the associated weight, is above the predetermined threshold.

Next at block 304, the embodiments of the invention further include comparing the updated retirement score to predetermined threshold associated with the retirement score. In response, the system may be configured to determine whether the retirement plan of the user is capable of withstanding the one or more life events based on at least the comparison. In some embodiments, in response to determining that the user's retirement plan is capable of withstanding the one or more life events, the system may be configured to transmit control signals configured to cause a mobile device associated with the user to receive a message. The message indicates that the user's retirement plan is capable of withstanding the one or more life events. In one aspect, the message comprises an updated retirement score, and the one or more life events used in performing the stress test on the retirement plan.

In response, the system may be configured to determine whether the retirement plan of the user is capable of withstanding the one or more life events based on at least the comparison, as shown in block 306. In this regard, the system may be configured to determine that the retirement plan of the user is capable of withstanding the one or more life events if the updated retirement score is greater than the predetermined threshold.

In accordance with embodiments of the invention, the term “module” with respect to a system may refer to a hardware component of the system, a software component of the system, or a component of the system that includes both hardware and software. As used herein, a module may include one or more modules, where each module may reside in separate pieces of hardware or software.

Although many embodiments of the present invention have just been described above, the present invention may be embodied in many different forms and should not be construed as limited to the embodiments set forth herein; rather, these embodiments are provided so that this disclosure will satisfy applicable legal requirements. Also, it will be understood that, where possible, any of the advantages, features, functions, devices, and/or operational aspects of any of the embodiments of the present invention described and/or contemplated herein may be included in any of the other embodiments of the present invention described and/or contemplated herein, and/or vice versa. In addition, where possible, any terms expressed in the singular form herein are meant to also include the plural form and/or vice versa, unless explicitly stated otherwise. Accordingly, the terms “a” and/or “an” shall mean “one or more,” even though the phrase “one or more” is also used herein. Like numbers refer to like elements throughout.

As will be appreciated by one of ordinary skill in the art in view of this disclosure, the present invention may include and/or be embodied as an apparatus (including, for example, a system, machine, device, computer program product, and/or the like), as a method (including, for example, a business method, computer-implemented process, and/or the like), or as any combination of the foregoing. Accordingly, embodiments of the present invention may take the form of an entirely business method embodiment, an entirely software embodiment (including firmware, resident software, micro-code, stored procedures in a database, or the like), an entirely hardware embodiment, or an embodiment combining business method, software, and hardware aspects that may generally be referred to herein as a “system.” Furthermore, embodiments of the present invention may take the form of a computer program product that includes a computer-readable storage medium having one or more computer-executable program code portions stored therein. As used herein, a processor, which may include one or more processors, may be “configured to” perform a certain function in a variety of ways, including, for example, by having one or more general-purpose circuits perform the function by executing one or more computer-executable program code portions embodied in a computer-readable medium, and/or by having one or more application-specific circuits perform the function.

It will be understood that any suitable computer-readable medium may be utilized. The computer-readable medium may include, but is not limited to, a non-transitory computer-readable medium, such as a tangible electronic, magnetic, optical, electromagnetic, infrared, and/or semiconductor system, device, and/or other apparatus. For example, in some embodiments, the non-transitory computer-readable medium includes a tangible medium such as a portable computer diskette, a hard disk, a random access memory (RAM), a read-only memory (ROM), an erasable programmable read-only memory (EPROM or Flash memory), a compact disc read-only memory (CD-ROM), and/or some other tangible optical and/or magnetic storage device. In other embodiments of the present invention, however, the computer-readable medium may be transitory, such as, for example, a propagation signal including computer-executable program code portions embodied therein.

One or more computer-executable program code portions for carrying out operations of the present invention may include object-oriented, scripted, and/or unscripted programming languages, such as, for example, Java, Perl, Smalltalk, C++, SAS, SQL, Python, Objective C, JavaScript, and/or the like. In some embodiments, the one or more computer-executable program code portions for carrying out operations of embodiments of the present invention are written in conventional procedural programming languages, such as the “C” programming languages and/or similar programming languages. The computer program code may alternatively or additionally be written in one or more multi-paradigm programming languages, such as, for example, F#.

Some embodiments of the present invention are described herein with reference to flowchart illustrations and/or block diagrams of apparatus and/or methods. It will be understood that each block included in the flowchart illustrations and/or block diagrams, and/or combinations of blocks included in the flowchart illustrations and/or block diagrams, may be implemented by one or more computer-executable program code portions. These one or more computer-executable program code portions may be provided to a processor of a general purpose computer, special purpose computer, and/or some other programmable data processing apparatus in order to produce a particular machine, such that the one or more computer-executable program code portions, which execute via the processor of the computer and/or other programmable data processing apparatus, create mechanisms for implementing the steps and/or functions represented by the flowchart(s) and/or block diagram block(s).

The one or more computer-executable program code portions may be stored in a transitory and/or non-transitory computer-readable medium (e.g. a memory) that can direct, instruct, and/or cause a computer and/or other programmable data processing apparatus to function in a particular manner, such that the computer-executable program code portions stored in the computer-readable medium produce an article of manufacture including instruction mechanisms which implement the steps and/or functions specified in the flowchart(s) and/or block diagram block(s).

The one or more computer-executable program code portions may also be loaded onto a computer and/or other programmable data processing apparatus to cause a series of operational steps to be performed on the computer and/or other programmable apparatus. In some embodiments, this produces a computer-implemented process such that the one or more computer-executable program code portions which execute on the computer and/or other programmable apparatus provide operational steps to implement the steps specified in the flowchart(s) and/or the functions specified in the block diagram block(s). Alternatively, computer-implemented steps may be combined with, and/or replaced with, operator- and/or human-implemented steps in order to carry out an embodiment of the present invention.

While certain exemplary embodiments have been described and shown in the accompanying drawings, it is to be understood that such embodiments are merely illustrative of and not restrictive on the broad invention, and that this invention not be limited to the specific constructions and arrangements shown and described, since various other changes, combinations, omissions, modifications and substitutions, in addition to those set forth in the above paragraphs, are possible. Those skilled in the art will appreciate that various adaptations, modifications, and combinations of the just described embodiments can be configured without departing from the scope and spirit of the invention. Therefore, it is to be understood that, within the scope of the appended claims, the invention may be practiced other than as specifically described herein.

### INCORPORATION BY REFERENCE

To supplement the present disclosure, this application further incorporates entirely by reference the following commonly assigned patent applications:

| | U.S. Patent Appli- | | |
|---|---|---|---|
| Docket Number | cation Ser. No. | Title | Filed On |
| 6566US1.014033.2425 | 14/664,226 | A SYSTEM FOR OPTIMIZING | Mar. 20, 2015 |
| | | INVESTING AND/OR DEBT | |
| | | REDUCTION | |
| 6576US1.014033.2426 | 14/664,631 | A SYSTEM FOR ASSESSING | Mar. 20, 2015 |
| | | RETIREMENT PLANNING BASED | |
| | | ON A RETIREMENT SCORE | |
| 6577US1.014033.2427 | 14/664,473 | SYSTEM FOR ACCOUNT LINKING | Mar. 20, 2015 |
| | | AND FUTURE EVENT | |
| | | INTEGRATION INTO RETIREMENT | |
| | | SCORE CALCULATION | |
| 6578US1.014033.2428 | 14/664,193 | A SYSTEM FOR UTILIZING A | Mar. 20, 2015 |
| | | RETIREMENT SCORE TO RECEIVE | |
| | | BENEFITS | |
| 6579US1.014033.2429 | 14/664,210 | A SYSTEM FOR RETIREMENT | Mar. 20, 2015 |
| | | SCORE TRANSMFORMATION | |
| | | USING OPTIMIZATION | |
| 6581US1.014033.2430 | 14/664,542 | A SYSTEM FOR ASSESSING | Mar. 20, 2015 |
| | | IMPACT OF LIFE EVENTS ON | |
| | | RETIREMENT PLANNING | |
| 6582US1.014033.2431 | 14/664,667 | SYSTEM FOR SHARING | Mar. 20, 2015 |
| | | RETIREMENT SCORES BETWEEN | |
| | | SOCIAL GROUPS OF CUSTOMERS | |
| 6583US1.014033.2432 | 14/664,239 | A SYSTEM UTILIZING A | Mar. 20, 2015 |
| | | RETIREMENT SCORE TO ASSESS | |
| | | AN ABILITY TO SURVIVE A | |
| | | MARKET EVENT BASED ON USER | |
| | | INVESTMENTS | |
| 6584US1.014033.2433 | 14/664,610 | SYSTEM FOR AUGMENTING A | Mar. 20, 2015 |
| | | RETIREMENT SCORE WITH | |
| | | HEALTH INFORMATION | |

What is claimed is:

1. A system for performing a stress test on a retirement plan, the system comprising:
one or more memory devices; and
one or more processing devices operatively coupled to the one or more memory devices, wherein the one or more processing devices are configured to execute computer-readable program code to:
receive one or more parameters associated with financial institution accounts of the user from a distributed network of servers, wherein the one or more parameters comprises at least asset values, liability values, and estimated rates of return associated with assets that provide returns;
determine a user profile associated with the user, the user profile comprising an age of the user;
determine financial behavior of the user, wherein the financial behavior comprises at least one of a spending behavior, investment behavior, and savings behavior;
calculate a retirement score for a retirement plan of a user based on the one or more parameters, wherein the one or more parameters comprise at least asset values, liability values, the user profile, the estimated rates of return associated with assets that provide returns, and a financial behavior of the user, wherein the retirement score indicates the user's preparedness for retirement at a future predetermined date, wherein the future predetermined date is selected by the user;
determine one or more life events likely to occur for the user, wherein the one or more life events comprises a life event score;
perform a stress test on the retirement plan of the user based on at least the one or more life events, wherein performing a stress comprises:
calculating an updated retirement score based on at least the one or more life event scores associated with the one or more life events likely to occur for the user;
compare the updated retirement score to a predetermined threshold associated with the retirement score; and
determine whether the retirement plan of the user is capable of withstanding the one or more life events based on at least the comparison; and
provide one or more recommendations to the user based on at least determining that the retirement plan of the user is not capable of withstanding the one or more life events.

2. The system of claim 1, wherein the module is configured to cause the one or more processing devices to determine the one or more life events likely to occur for the user based on at least the user profile and one or more life events that have occurred to peer users with peer user profiles substantially similar to the user profile.

3. The system of claim 1, wherein the module is configured to cause the one or more processing devices to:
determine one or more weights associated with the likelihood of the one or more life events determined to occur for the user; and
calculate the updated retirement score based on at least weighting the one or more life event scores likely to occur for the user.

4. The system of claim 3, wherein the module is configured to cause the one or more processing devices to:
initiate the stress test on the retirement plan based on a predetermined threshold associated with the one or more weights, wherein the stress test is initiated when a value of at least one of the one or more weights is greater than the predetermined threshold.

5. The system of claim 3, wherein the module is configured to cause the one or more processing devices to:
vary a value of the one or more weights associated with the likelihood of the one or more life events determined to occur for the user, wherein the value of the one or more weights is varied based on at least the user's profile.

6. The system of claim 1, wherein the module is configured to cause the one or more processing devices to:
perform the stress test on the retirement plan of the user at one or more time intervals associated with the one or more life events, wherein the one or more time intervals are based on at least the user's age.

7. The system of claim 1, wherein the module is configured to cause the one or more processing devices to:
enable the user to customize the one or more life events determined likely to occur for the user.

8. A computer program product for performing a stress test on a retirement plan, the computer program product comprising a non-transitory computer-readable medium comprising code causing a first apparatus to:
receive one or more parameters associated with financial institution accounts of the user from a distributed network of servers, wherein the one or more parameters comprises at least asset values, liability values, and estimated rates of return associated with assets that provide returns;
determine a user profile associated with the user, the user profile comprising an age of the user;
determine financial behavior of the user, wherein the financial behavior comprises at least one of a spending behavior, investment behavior, and savings behavior;
calculate a retirement score for a retirement plan of a user based on the one or more parameters, wherein the one or more parameters comprise at least asset values, liability values, the user profile, the estimated rates of return associated with assets that provide returns, and a financial behavior of the user, wherein the retirement score indicates the user's preparedness for retirement at a future predetermined date, wherein the future predetermined date is selected by the user;
determine one or more life events likely to occur for the user, wherein the one or more life events comprises a life event score;
perform a stress test on the retirement plan of the user based on at least the one or more life events, wherein performing a stress comprises:
calculating an updated retirement score based on at least the one or more life event scores associated with the one or more life events likely to occur for the user;
compare the updated retirement score to a predetermined threshold associated with the retirement score; and
determine whether the retirement plan of the user is capable of withstanding the one or more life events based on at least the comparison; and
provide one or more recommendations to the user based on at least determining that the retirement plan of the user is not capable of withstanding the one or more life events.

9. The computer program product of claim 8, wherein the first apparatus is further configured to cause a processor to determine the one or more life events likely to occur for the user based on at least the user profile and one or more life events that have occurred to peer users with peer user profiles substantially similar to the user profile.

10. The computer program product of claim 8, wherein the first apparatus is further configured to cause a processor to:
determine one or more weights associated with the likelihood of the one or more life events determined to occur for the user; and
calculate the updated retirement score based on at least weighting the one or more life event scores likely to occur for the user.

11. The computer program product of claim 10, wherein the first apparatus is further configured to cause a processor to:
initiate the stress test on the retirement plan based on a predetermined threshold associated with the one or more weights, wherein the stress test is initiated when a value of at least one of the one or more weights is greater than the predetermined threshold.

12. The computer program product of claim 10, wherein the first apparatus is further configured to cause a processor to:
vary a value of the one or more weights associated with the likelihood of the one or more life events determined to occur for the user, wherein the value of the one or more weights is varied based on at least the user's profile.

13. The computer program product of claim 8, wherein the first apparatus is further configured to cause a processor to:
perform the stress test on the retirement plan of the user at one or more time intervals associated with the one or more life events, wherein the one or more time intervals are based on at least the user's age.

14. The computer program product of claim 8, wherein the first apparatus is further configured to cause a processor to:
enable the user to customize the one or more life events determined likely to occur for the user.

15. A computer implemented method for performing a stress test on a retirement plan, the method comprising:
receiving, using a computing device processor, one or more parameters associated with financial institution accounts of the user from a distributed network of servers, wherein the one or more parameters comprises at least asset values, liability values, and estimated rates of return associated with assets that provide returns;
determining, using a computing device processor, a user profile associated with the user, the user profile comprising an age of the user;
determining, using a computing device processor, financial behavior of the user, wherein the financial behavior comprises at least one of a spending behavior, investment behavior, and savings behavior;
calculating, using a computing device processor, a retirement score for a retirement plan of a user based on the one or more parameters, wherein the one or more parameters comprise at least asset values, liability values, the user profile, the estimated rates of return associated with assets that provide returns, and a financial behavior of the user, wherein the retirement score indicates the user's preparedness for retirement at a future predetermined date, wherein the future predetermined date is selected by the user;
determining, using a computing device processor, one or more life events likely to occur for the user, wherein the one or more life events comprises a life event score;
performing, using a computing device processor, a stress test on the retirement plan of the user based on at least the one or more life events, wherein performing a stress comprises:
calculating an updated retirement score based on at least the one or more life event scores associated with the one or more life events likely to occur for the user;
compare the updated retirement score to a predetermined threshold associated with the retirement score; and
determine whether the retirement plan of the user is capable of withstanding the one or more life events based on at least the comparison; and
providing, using a computing device processor, one or more recommendations to the user based on at least determining that the retirement plan of the user is not capable of withstanding the one or more life events.

16. The computer implemented method of claim 15, wherein the method further comprises determining the one or more life events likely to occur for the user based on at least the user profile and one or more life events that have occurred to peer users with peer user profiles substantially similar to the user profile.

17. The computer implemented method of claim 15, wherein the method further comprises:
determining one or more weights associated with the likelihood of the one or more life events determined to occur for the user; and
calculating the updated retirement score based on at least weighting the one or more life event scores likely to occur for the user.

18. The computer implemented method of claim 17, wherein the method further comprises:
initiating the stress test on the retirement plan based on a predetermined threshold associated with the one or more weights, wherein the stress test is initiated when a value of at least one of the one or more weights is greater than the predetermined threshold.

19. The computer implemented method of claim 17, wherein the method further comprises:
varying a value of the one or more weights associated with the likelihood of the one or more life events determined to occur for the user, wherein the value of the one or more weights is varied based on at least the user's profile.

20. The computer implemented method of claim 15, wherein the method further comprises:
performing the stress test on the retirement plan of the user at one or more time intervals associated with the one or more life events, wherein the one or more time intervals are based on at least the user's age.
